(19) United States
(12) Patent Application Publication
(10) Pub. No.: US 2025/0357685 A1
(43) Pub. Date: Nov. 20, 2025

(54) TERMINAL BLOCK

(71) Applicant: Yazaki Corporation, Tokyo (JP)

(72) Inventors: Yasuhiro TANAKA, Shizuoka (JP); Yasuhiro Otsuta, Shizuoka (JP); Yusuke Tsutagawa, Shizuoka (JP); Masatoshi Yamada, Shizuoka (JP); Masato Akino, Shizuoka (JP); Katsuya Nakano, Shizuoka (JP); Sota Arai, Shizuoka (JP)

(73) Assignee: Yazaki Corporation, Tokyo (JP)

(21) Appl. No.: 19/169,197

(22) Filed: Apr. 3, 2025

(30) Foreign Application Priority Data
May 20, 2024 (JP) 2024-081584

(51) Int. Cl. H01R 9/24

(52) U.S. Cl. CPC H01R 9/24

(57) ABSTRACT

A terminal block includes a bus bar including a through hole, a nut including a screw hole, a housing including a holding portion that holds the bus bar and a recess that holds the nut with the screw hole caused to face the through hole, and a bolt inserted into the through hole and screwed in the nut housed in the recess. The nut includes a facing surface facing the bus bar and a protrusion protruding from the facing surface toward the bus bar. The bus bar includes a housing hole that engages with the protrusion and restrict rotation of the nut.

### CROSS-REFERENCE TO RELATED APPLICATION(S)

The present application claims priority to and incorporates by reference the entire contents of Japanese Patent Application No. 2024-081584 filed in Japan on May 20, 2024.

### BACKGROUND OF THE INVENTION

### 1. Field of the Invention

The present invention relates to a terminal block.

### 2. Description of the Related Art

There has been a technique of co-fastening two conductive members with a nut and a bolt. JP 2021-089 881 A discloses a housing including a nut holding portion that holds a nut. A terminal portion of a conductor held by the housing is co-fastened with a mating terminal by a bolt and a nut.

When the bolt is screwed into the nut held by the housing, torque of rotating the nut together with the bolt acts on the nut. When the rotation of the nut is about to be regulated by the housing against this torque, it is necessary to increase the thickness of the housing, causing an increase in the size of the housing.

### SUMMARY OF THE INVENTION

An object of the present invention is to provide a terminal block that can suppress an increase in the size of a housing.

In order to achieve the above mentioned object, a terminal block according to one aspect of the present invention includes a bus bar including a through hole; a nut including a screw hole; a housing including a holding portion that holds the bus bar, and a recess that holds the nut with the screw hole caused to face the through hole; and a bolt inserted into the through hole and screwed in the nut housed in the recess, wherein the nut includes a facing surface facing the bus bar, and a protrusion protruding from the facing surface toward the bus bar, and the bus bar includes a housing hole that engages with the protrusion and restricts rotation of the nut.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a terminal block according to an embodiment;

FIG. 2 is an exploded perspective view illustrating the terminal block according to the embodiment;

FIG. 3 is a front view illustrating a housing according to the embodiment;

FIG. 4 is a cross-sectional view illustrating the housing according to the embodiment;

FIG. 5 is a plan view illustrating a nut according to the embodiment;

FIG. 6 is a perspective view illustrating the nut according to the embodiment;

FIG. 7 is a plan view illustrating a bus bar according to the embodiment;

FIG. 8 is a plan view illustrating the bus bar according to the embodiment;

FIG. 9 is a cross-sectional view illustrating the terminal block according to the embodiment;

FIG. 10 is a cross-sectional view illustrating the terminal block according to the embodiment;

FIG. 11 is a cross-sectional view illustrating the terminal block according to the embodiment;

FIG. 12 is a cross-sectional view illustrating the terminal block according to the embodiment;

FIG. 13 is a cross-sectional view illustrating the terminal block according to the embodiment; and

FIG. 14 is a cross-sectional view illustrating the terminal block according to the embodiment.

### DETAILED DESCRIPTION OF THE PREFERRED EMBODIMENTS

A terminal block according to an embodiment of the present invention is explained in detail below with reference to the drawings. Note that the present invention is not limited by the embodiment. Components in the embodiment explained below include components that can be easily assumed by those skilled in the art or components that are substantially the same.

### Embodiment

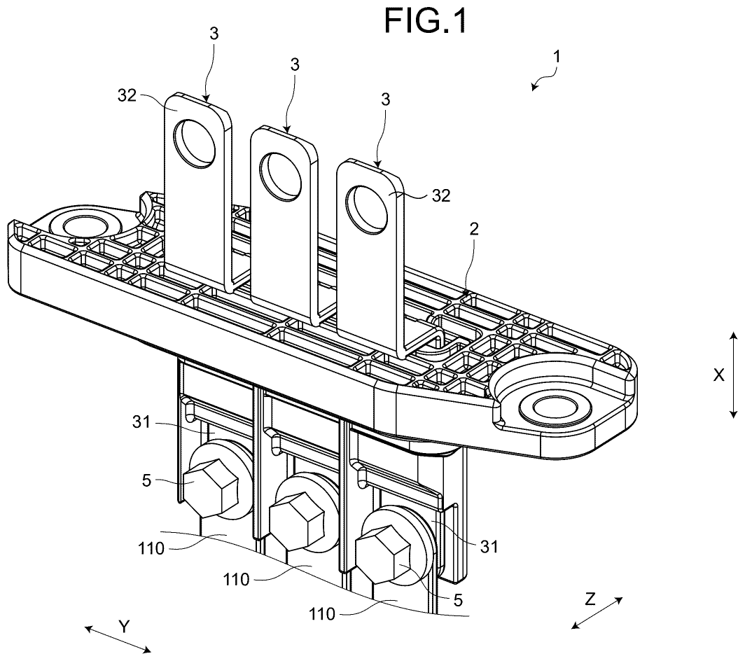

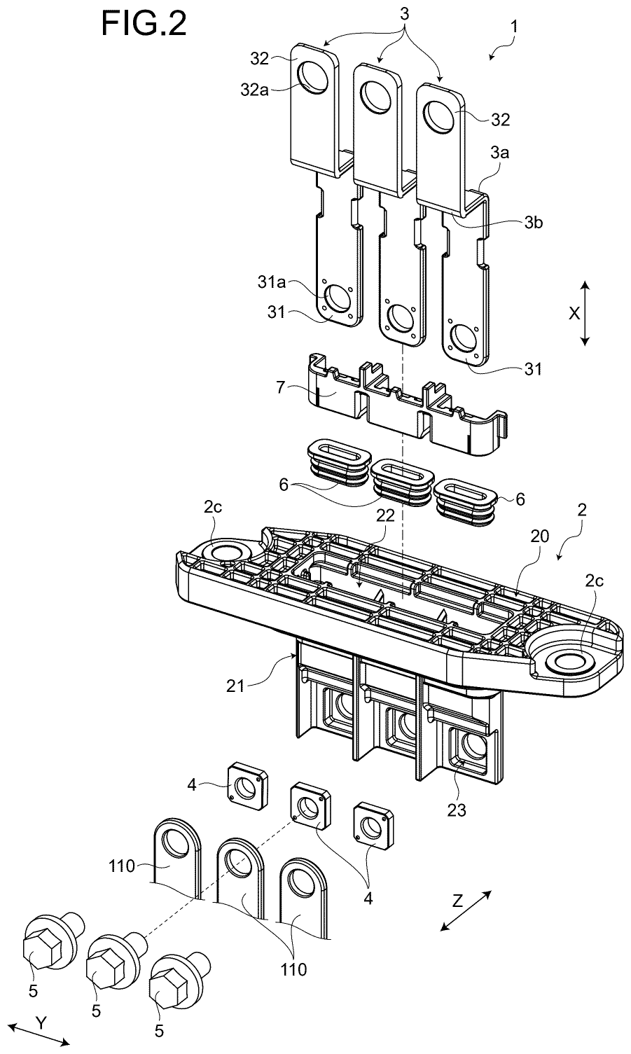

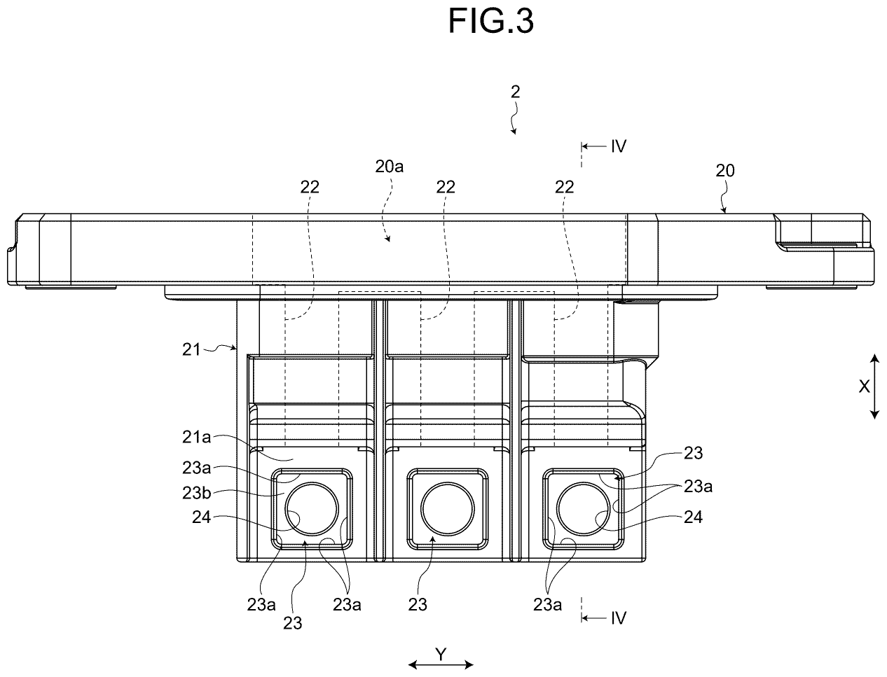

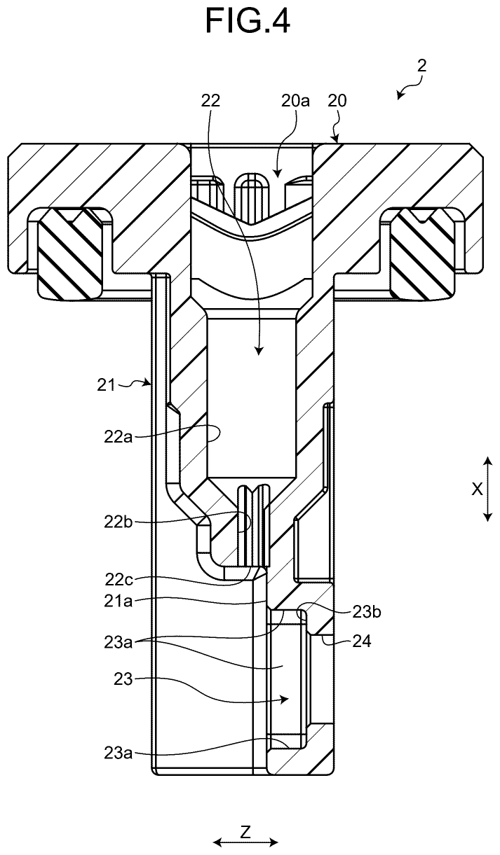

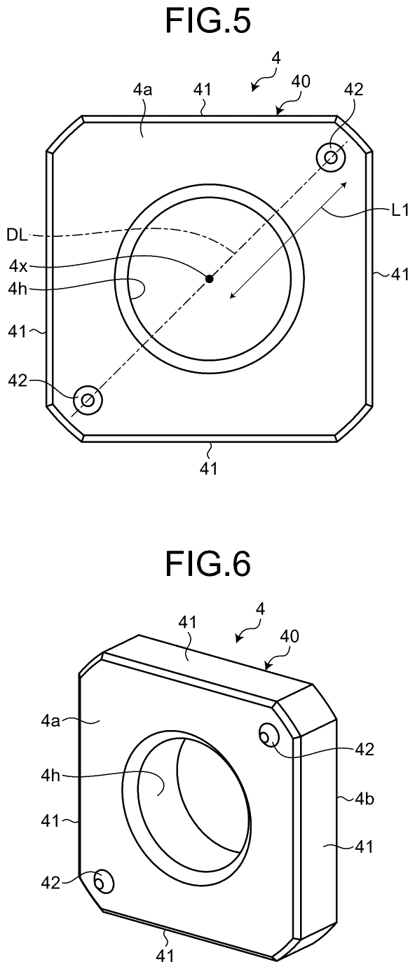

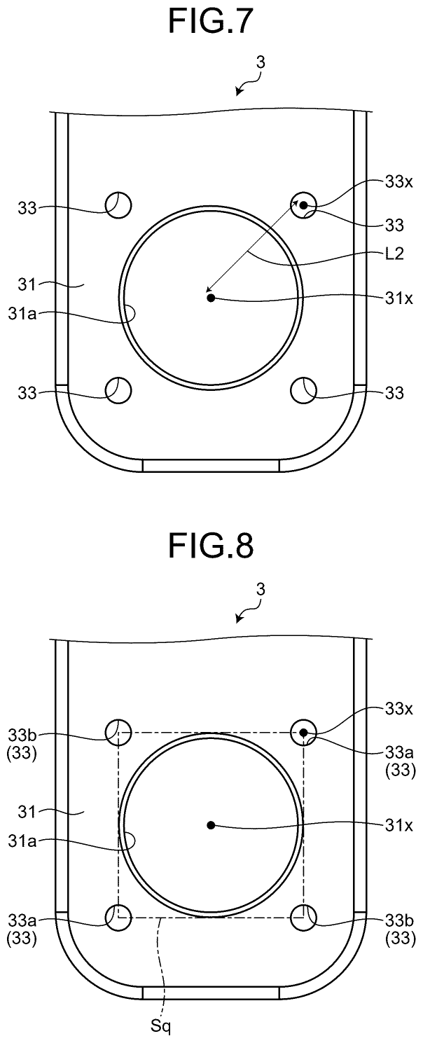

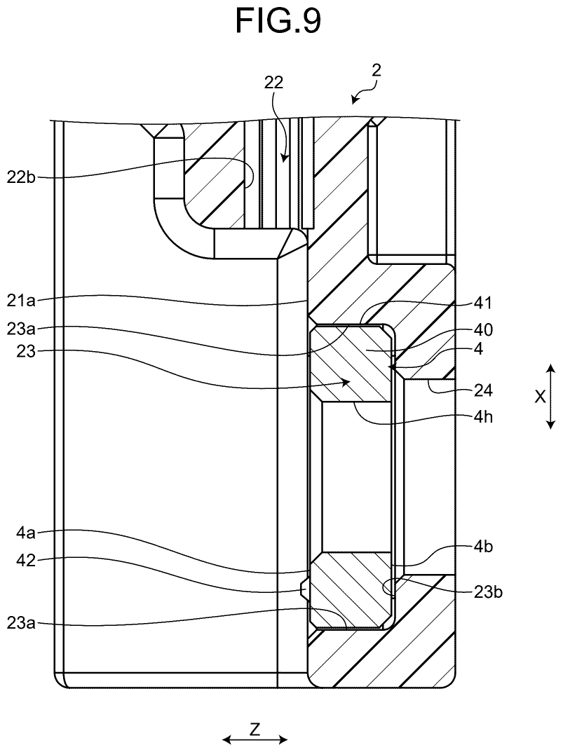

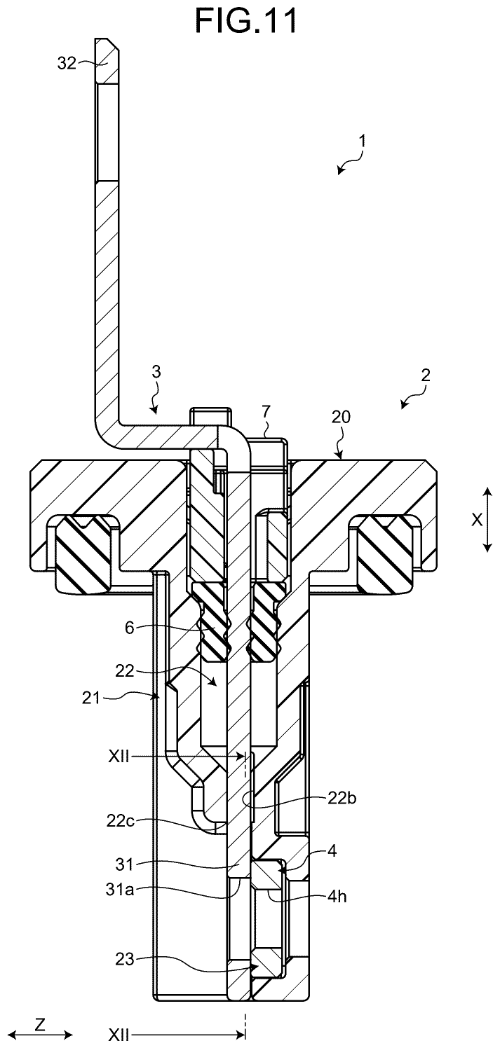

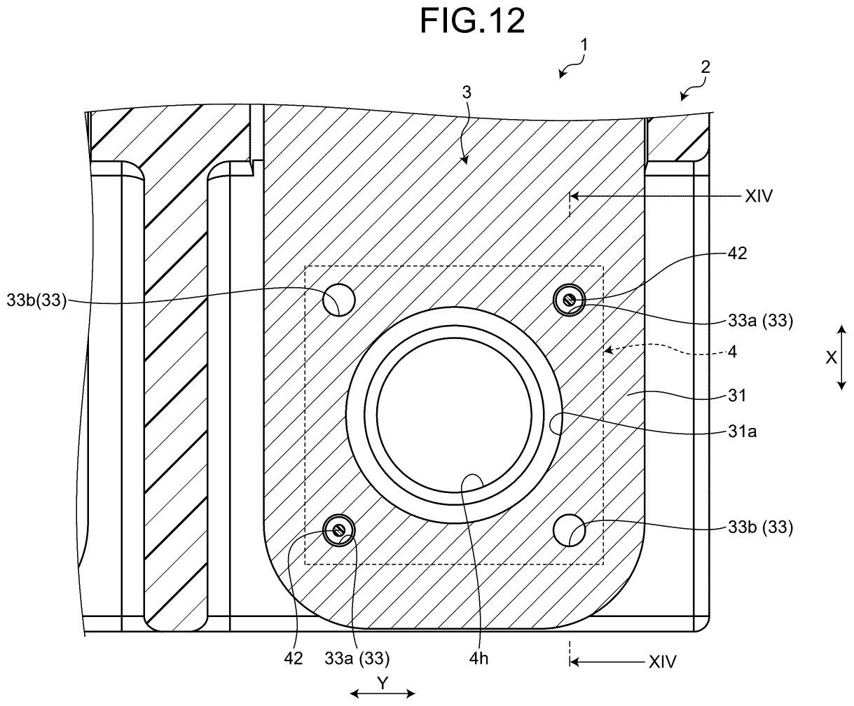

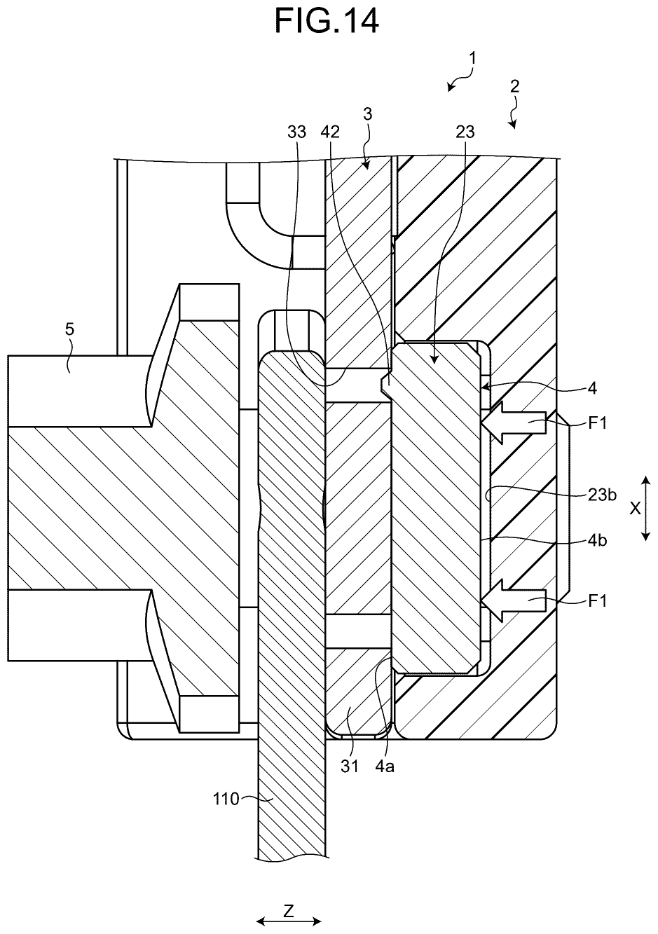

An embodiment is explained with reference to FIGS. 1 to 14. The present embodiment relates to a terminal block. FIG. 1 is a perspective view illustrating the terminal block according to the embodiment, FIG. 2 is an exploded perspective view illustrating the terminal block according to the embodiment, FIG. 3 is a front view illustrating a housing according to the embodiment, FIG. 4 is a cross-sectional view illustrating the housing according to the embodiment, FIG. 5 is a plan view illustrating a nut according to the embodiment, FIG. 6 is a perspective view illustrating the nut according to the embodiment, FIGS. 7 and 8 are plan views of a bus bar according to the embodiment, and FIGS. 9 to 14 are cross-sectional views of the terminal block according to the embodiment. In FIG. 4, a IV-IV cross section of FIG. 3 is illustrated. In FIG. 12, a XII-XII cross section of FIG. 11 is illustrated. In FIG. 14, a XIV-XIV cross of FIG. 12 is illustrated.

As illustrated in FIG. 1, a terminal block 1 in the present embodiment includes a housing 2 and three bus bars 3. The bus bar 3 electrically connects, for example, a first device and a second device. The two devices may be a motor and an inverter mounted on a vehicle. The housing 2 is fixed to, for example, a housing of the first device. A first terminal portion 31 of the bus bar 3 is connected to a terminal 110 of the first device.

As illustrated in FIG. 2, the terminal block 1 includes a nut 4 held by the housing 2 and a bolt 5 screwed in the nut 4. The bus bar 3 and the terminal 110 are fastened by the nut 4 and the bolt 5. The terminal block 1 in the present embodiment is configured to be able to reduce a load on the housing 2 at the time when the bolt 5 is screwed in the nut 4.

The bus bar 3 is formed of a metal plate having conductivity. As illustrated in FIG. 2, each of the bus bars 3 includes a first terminal portion 31 and a second terminal portion 32. The first terminal portion 31 is one end portion in the longitudinal direction in the bus bar 3. The second terminal portion 32 is another end portion in the longitudinal direction in the bus bar 3. Both of the first terminal portion 31 and the second terminal portion 32 has a flat plate shape. Circular through holes 31a and 32a are provided in the first terminal portion 31 and the second terminal portion 32.

The bus bar 3 includes bent portions 3a and 3b formed between the first terminal portion 31 and the second terminal portion 32. The bus bar 3 is bent at a right angle at each of the two bent portions 3a and 3b. The two bent portions 3a and 3b are formed such that the two terminal portions 31 and 32 protrude in opposite directions. The first terminal portion 31 is connected to the terminal 110 of the first device and the second terminal portion 32 is connected to a terminal or the like of the second device.

The housing 2 is a member including a holding portion for holding the bus bar 3 and a recess 23 for holding the nut 4. The housing 2 is molded from, for example, insulative synthetic resin. The housing 2 includes a main body 20 and a support wall 21. The main body 20 is a portion fixed to the first device and has a substantially flat plate shape. Collars 2c made of metal are disposed at both end portions of the main body 20. The housing 2 is fixed to the first device by bolts inserted through the collars 2c.

The support wall 21 is erected from the main body 20 in the thickness direction of the main body 20. A plurality of bus bars 3 are inserted into the housing 2 to pierce through the main body 20 and the support wall 21. The housing 2 holds the plurality of bus bars 3 side by side. In the present specification, a direction in which the bus bars 3 are inserted into the housing 2 is referred to as first direction X and an arrangement direction of the plurality of bus bars 3 in the housing 2 is referred to as second direction Y. A direction orthogonal to both of the first direction X and the second direction Y is referred to as third direction Z. The third direction Z is a thickness direction of the bus bars 3 held by the housing 2. The bolt 5 is screwed in, in the third direction Z, the nut 4 held by the housing 2.

As illustrated in FIG. 3, the support wall 21 protrudes from the main body 20 in the first direction X. The width direction of the support wall 21 is the second direction Y and the thickness direction of the support wall 21 is the third direction Z. As illustrated in FIG. 3, the shape of the support wall 21 when viewed in the third direction Z is a substantial rectangle.

As illustrated in FIG. 3, three through holes 22 and three recesses 23 are provided in the support wall 21. The three through holes 22 and the three recesses 23 are disposed at intervals in the second direction Y. The three through holes 22 are opened to a recess 20a of the main body 20.

As illustrated in FIG. 4, the through hole 22 pierces through the housing 2 in the first direction X. One end of the through hole 22 is opened to the recess 20a of the main body 20. The recess 20a is opened toward a side opposite to the side of the support wall 21 side. The through hole 22 includes a housing portion 22a and a holding portion 22b. The housing portion 22a is a portion that houses a gasket 6 attached to the bus bar 3. As illustrated in FIG. 2, a holder 7 and an annular gasket 6 are mounted on the bus bar 3. The plurality of bus bars 3 are inserted into one holder 7. The holder 7 holds three bus bars 3 side by side.

The gasket 6 is disposed between the first terminal portion 31 and the holder 7. A bus bar unit including the bus bar 3, the holder 7, and the gasket 6 is inserted into the housing 2 with the first terminal portion 31 set as a head. At this time, the holder 7 is housed in the recess 20a of the main body 20 while supporting an end face of the gasket 6 and the gasket 6 is inserted into the housing portion 22a. The gasket 6 seals a space between a wall surface of the housing portion 22a and the bus bar 3.

The holding portion 22b illustrated in FIG. 4 is a portion that holds the bus bar 3. Each bus bar 3 is held by the holding portion 22b of the through hole 22 corresponding to the bus bar 3. The bus bar 3 may be press-fit into the holding portion 22b. The holding portion 22b includes, for example, a rib for holding the bus bar 3. In this case, the rib protrudes in the third direction Z from the inner wall surface of the holding portion 22b. The rib for holding the bus bar 3 may be a crushing rib.

As illustrated in FIGS. 3 and 4, the recess 23 is disposed at the distal end portion in the first direction X in the support wall 21. In other words, the recess 23 is disposed at the end portion on a side far from the main body 20 in the support wall 21. The housing 2 in the present embodiment includes three recesses 23 arranged in the second direction Y. The recess 23 is opened in the third direction Z. The shape of the recess 23 when viewed in the third direction Z is a rectangle, for example, a square.

The recess 23 includes four facing surfaces 23a and one bottom surface 23b. The four facing surfaces 23a form a rectangular frame that houses the nut 4. Among the four facing surfaces 23a, two facing surfaces 23a face each other in the first direction X and the other two facing surfaces 23a face each other in the second direction Y. The facing surface 23a faces a side surface 41 of the nut 4. The bottom surface 23b is connected to the facing surface 23a and forms a bottom surface of a housing chamber that houses the nut 4. The support wall 21 includes a plane 21a surrounding the recess 23.

In the support wall 21, a through hole 24 connected to the recess 23 is provided. The through hole 24 is opened in the bottom surface 23b of the recess 23 and pierces through the support wall 21 in the third direction Z. The cross-sectional shape of the through hole 24 in a surface orthogonal to the third direction Z is a circle. The through hole 24 houses the distal end portion of the bolt 5.

As illustrated in FIG. 4, the through hole 22 includes an opening 22c. The first terminal portion 31 of the bus bar 3 protrudes from the opening 22c to an external space. The opening 22c is disposed adjacent to one facing surface 23a of the recess 23. The first terminal portion 31 protruding from the opening 22c faces the bottom surface 23b of the recess 23 in the third direction Z.

As illustrated in FIGS. 5 and 6, the shape of the nut 4 in the present embodiment is a rectangle. The nut 4 includes a main body 40 and a protrusion 42 protruding from the main body 40. In the main body 40, a screw hole 4h piercing through the main body 40 is formed.

The shape of the main body 40 when viewed from the direction of a center axis 4x of the screw hole 4h is a square. Four corners of the main body 40 have a chamfered shape. The main body 40 includes a front surface 4a and a rear surface 4b. The front surface 4a is one of two main surfaces of the main body 40. The front surface 4a faces the bus bar 3 and a mating terminal 110. The rear surface 4b is another one of the two main surfaces of the main body 40. The rear surface 4b faces the bottom surface 23b of the recess 23. The main body 40 includes four side surfaces 41. The four side surfaces 41 face the facing surface 23a of the recess 23.

The protrusion 42 protrudes from the front surface 4a of the main body 40. The nut 4 in the present embodiment includes two protrusions 42. The two protrusions 42 are disposed concentrically centering on the center axis 4x. That is, the two protrusions 42 are disposed on the same circumference centering on the center axis 4x. The protrusion 42 is disposed at a position at a distance L1 from the center axis 4x. The distance L1 is a distance in the radial direction centering on the center axis 4x and is a distance to the center of the protrusion 42.

The shape of the protrusion 42 in the present embodiment is a tapered shape, the cross-sectional area of which decreases further away from the front surface 4a. An exemplified shape of the protrusion 42 is a truncated cone shape. That is, the cross-sectional shape of the protrusion 42 on the surface parallel to the front surface 4a is a circle. The cross-sectional area of the protrusion 42 decreases further away from the front surface 4a. The shape of the distal end of the protrusion 42 is a plane parallel to the front surface 4a.

As illustrated in FIG. 7, a housing hole 33 configured to engage with the protrusion 42 is formed in the first terminal portion 31 of the bus bar 3. The housing hole 33 in the present embodiment is a through hole piercing through the first terminal portion 31. The housing hole 33 pierces through the first terminal portion 31 in the thickness direction of the first terminal portion 31. The first terminal portion 31 in the present embodiment includes four housing holes 33. The four housing holes 33 are disposed concentrically centering on a center axis 31x of the through hole 31a. That is, the four housing holes 33 are disposed on the same circumference centering on the center axis 31x.

The housing hole 33 is disposed at the position at a distance L2 from the center axis 31x. The distance L2 is a distance in the radial direction centering on the center axis 31x and is a distance to a center 33x of the housing hole 33. A value of the distance L2 is equal to the value of the distance L1 of the nut 4.

The shape of the housing hole 33 in the present embodiment is a shape for enabling entire one protrusion 42 to be housed in the housing hole 33. An exemplified shape of the housing hole 33 is a columnar shape. That is, the shape of the housing hole 33 in a surface orthogonal to the center axis 31x is a circle. The cross-sectional area of the housing hole 33 is equal to or larger than the cross-sectional area of the protrusion 42. A value of the inner diameter of the housing hole 33 is equal to or larger than a value of the maximum outer diameter of the protrusion 42.

The four housing holes 33 are disposed such that one of the four housing holes 33 can engage with any protrusion 42. That is, the first terminal portion 31 can cause any one of the housing holes 33 to engage with all of the protrusions 42 included in the nut 4.

In the terminal block 1 in the present embodiment, when the through hole 31a of the first terminal portion 31 faces the screw hole 4h of the nut 4, two of the four housing holes 33 of the first terminal portion 31 can engage with two protrusions 42 corresponding to the two housing holes 33. In the following explanation, a disposition example of the protrusions 42 and the housing holes 33 in the present embodiment is explained.

As illustrated in FIG. 5, the nut 4 has a diagonal line DL. The diagonal line DL is a straight line connecting diagonals of the main body 40. That is, the diagonal line DL is a diagonal line of a rectangle of the nut 4. The diagonal line DL intersects the center axis 4x. The protrusion 42 is disposed on the diagonal line DL. When the protrusion 42 is disposed on the diagonal line DL, the distance L1 from the center axis 4x to the protrusion 42 can be increased.

The two protrusions 42 are disposed on the diagonal line DL with the screw hole 4h interposed therebetween. That is, one protrusion 42 is disposed on one side along the diagonal line DL with respect to the screw hole 4h and the other protrusion 42 is disposed on the other side along the diagonal line DL with respect to the screw hole 4h.

As illustrated in FIG. 8, the four housing holes 33 include a pair of first housing holes 33a and a pair of second housing holes 33b. The four housing holes 33 are disposed at vertices of a square Sq centering on the center axis 31x. The pair of first housing holes 33a is disposed at a set of diagonal corners of the square Sq and the pair of second housing holes 33b is disposed at another set of diagonal corners.

When the bus bar 3 and the nut 4 are assembled to the housing 2, the pair of first housing holes 33a or the pair of second housing holes 33b faces the two protrusions 42 of the nut 4. When the first housing hole 33a faces the protrusion 42, one first housing hole 33a engages with one protrusion 42 and the other first housing hole 33a engages with the other protrusion 42. When the second housing hole 33b faces the protrusion 42, one second housing hole 33b engages with one protrusion 42 and the other second housing hole 33b engages with the other protrusion 42. Therefore, the four housing holes 33 are disposed such that one of the four housing holes 33 can engage with any protrusion 42 of the nut 4.

In FIG. 9, the nut 4 housed in the recess 23 is illustrated. The nut 4 is inserted into the recess 23 in a posture in which the rear surface 4b is directed to the bottom surface 23b of the recess 23. The recess 23 is configured to be able to house the entire main body 40 in the recess 23. The protrusion 42 protrudes from the recess 23 in the third direction Z. That is, the protrusion 42 protrudes toward a side opposite to the side of the recess 23 with respect to the plane 21a surrounding the recess 23.

The facing surface 23a of the recess 23 faces the side surface 41 of the nut 4 and positions the nut 4. The recess 23 holds the nut 4 such that two side surfaces 41 of the nut 4 are parallel to the first direction X and the other two side surfaces 41 are parallel to the second direction Y.

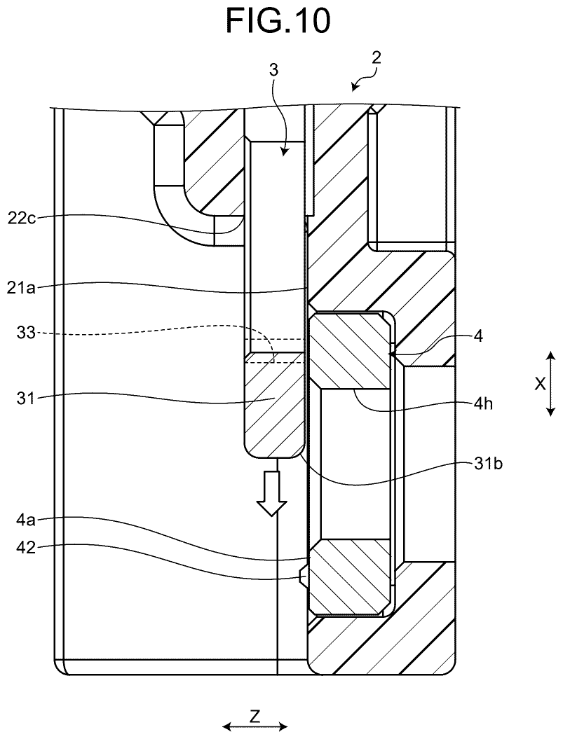

In FIG. 10, the bus bar 3 assembled to the housing 2 is illustrated. The first terminal portion 31 of the bus bar 3 protrudes from the opening 22c in the first direction X. The first terminal portion 31 advances along the plane 21a of the housing 2 and the front surface 4a of the nut 4. At this time, the first terminal portion 31 advances to a prescribed position while climbing over the protrusion 42 of the nut 4. An arc-shaped chamfered portion 31b capable of climbing on the protrusion 42 is formed at the distal end of the first terminal portion 31.

In FIGS. 11 and 12, the bus bar 3 positioned at a prescribed position is illustrated. The through hole 31a of the first terminal portion 31 faces the screw hole 4h of the nut 4 in the third direction Z. The terminal block 1 is designed to match the center axis 4x of the screw hole 4h and the center axis 31x of the through hole 31a when the bus bar 3 is present at the prescribed position.

As illustrated in FIG. 12, when the bus bar 3 is present at the prescribed position, the protrusion 42 of the nut 4 faces the housing hole 33 of the bus bar 3. At least a part of the protrusion 42 is inserted into the housing hole 33. In FIG. 12, the protrusion 42 is housed in each of the pair of first housing holes 33a. The nut 4 may be disposed such that the protrusion 42 faces the second housing hole 33b.

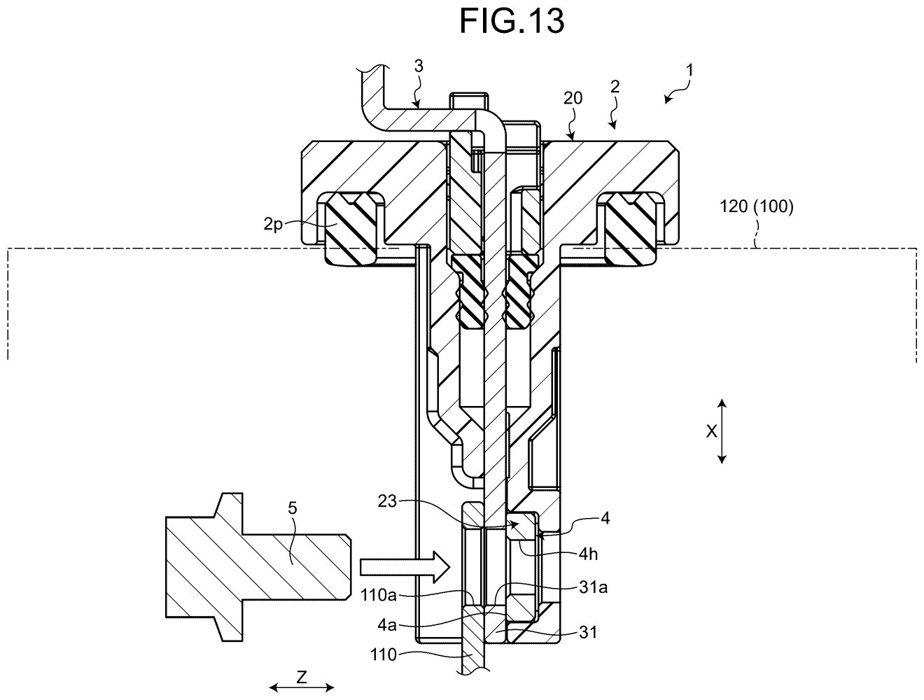

FIG. 13 illustrates the terminal block 1 fixed to a housing 120 of a first device 100. A space between the main body 20 of the housing 2 and the housing 120 is sealed by an annular surface seal 2p. The first terminal portion 31 is housed in the internal space of the housing 120. A terminal 110 of the first device 100 is disposed at a position facing the first terminal portion 31 and the nut 4. A through hole 110a of the terminal 110 faces the through hole 31a and the screw hole 4h in the third direction Z. The bolt 5 is inserted through two through holes 110a and 31a and screwed in the screw hole 4h of the nut 4.

FIG. 14 is a cross section of the terminal block 1 at a XIV-XIV position in FIG. 12. In FIG. 14, a cross section at the time when the bolt 5 is screwed in the nut 4 is illustrated. As illustrated in FIG. 14, the protrusion 42 of the nut 4 engages with the housing hole 33 of the bus bar 3 and restricts relative rotation of the nut 4 with respect to the bus bar 3.

A force F1 acts on the nut 4 with torque at the time when the bolt 5 is screwed in the nut 4. The force F1 is a force that presses the nut 4 toward the bus bar 3. That is, the force F1 is a force that presses the front surface 4a of the nut 4 toward the first terminal portion 31. The force F1 pushes in the protrusion 42 toward the housing hole 33. Therefore, when the bolt 5 is screwed into the nut 4, the nut 4 is pulled up from the bottom surface 23b of the recess 23 toward the first terminal portion 31. As the nut 4 approaches the first terminal portion 31, a range in which the nut 4 is capable of rotating with respect to the first terminal portion 31 becomes narrower. When the front surface 4a of the nut 4 adheres to the first terminal portion 31, the rotatable range of the nut 4 is the narrowest. When the front surface 4a comes into contact with the first terminal portion 31, the co-rotation of the nut 4 is restricted by both of a frictional force between the front surface 4a and the first terminal portion 31 and a force of the housing hole 33 locking the protrusion 42.

As explained above, in the terminal block 1 in the present embodiment, co-rotation of the nut 4 at the time when the first terminal portion 31 and the terminal 110 are fastened by the bolt 5 and the nut 4 is appropriately restricted. Since the co-rotation of the nut 4 is restricted by the protrusion 42, a load on the housing 2 at the time when the bolt 5 is screwed in the nut 4 is reduced. Since the load on the housing 2 is reduced, it is possible to reduce the thickness of the housing and reduce the housing 2 in size.

As explained above, the terminal block 1 in the present embodiment includes the bus bar 3 including the through hole 31a, the nut 4 including the screw hole 4h, the housing 2, and the bolt 5. The housing 2 includes the holding portion 22b that holds the bus bar 3 and the recess 23 that holds the nut 4 with the screw hole 4h caused to face the through hole 31a. The bolt 5 is inserted into the through hole 31a and screwed in the nut 4 housed in the recess 23. The nut 4 includes a front surface 4a and a protrusion 42 protruding from the front surface 4a. The front surface 4a is a facing surface facing the bus bar 3. The protrusion 42 protrudes from the front surface 4a toward the bus bar 3. The bus bar 3 includes the housing hole 33 that engages with the protrusion 42 and restricts rotation of the nut 4. In the terminal block 1 in the present embodiment, since the relative rotation of the nut 4 with respect to the bus bar 3 is restricted, a load on the housing 2 at the time when the bolt 5 is screwed in the nut 4 is reduced.

In the present embodiment, the shape of the nut 4 when viewed from the direction of the center axis 4x of the screw hole 4h is a rectangle. The protrusion 42 is disposed on the diagonal line DL of the rectangle. With such disposition, it is possible to enhance the effect of restricting co-rotation by increasing the distance L1 from the center axis 4x to the protrusion 42.

The nut 4 in the present embodiment includes the two protrusions 42 disposed on the diagonal line DL with the screw hole 4h interposed therebetween. Since the protrusions 42 are disposed on both the sides on the diagonal line DL with respect to the screw hole 4h, it is possible to enhance the effect of restricting the co-rotation of the nut 4.

The recess 23 in the present embodiment holds the nut 4 at a position where the protrusion 42 is caused to face the housing hole 33. With such a configuration, the action of restricting the co-rotation of the nut 4 with the protrusion 42 and the housing hole 33 is more securely exerted

The nut 4 in the present embodiment includes a plurality of protrusions 42. The plurality of protrusions 42 are disposed concentrically centering on the center axis 4x of the screw hole 4h. The bus bar 3 includes a plurality of housing holes 33. The plurality of housing holes 33 are disposed such that one of the plurality of housing holes 33 can engage with any protrusion 42. Since the plurality of protrusions 42 and the plurality of housing holes 33 engage with each other, the co-rotation of the nut 4 is effectively restricted.

The number of the protrusions 42 of the nut 4 is not limited to two exemplified above. For example, the nut 4 may include four protrusions 42. In this case, the four protrusions 42 may be disposed at vertices of a square centering on the center axis 4x. The nut 4 may include three protrusions 42. In this case, the three protrusions 42 may be disposed at the vertices of the square centering on the center axis 4x.

The number of the housing holes 33 included in the bus bar 3 is not limited to four exemplified above. The number of the housing holes 33 of the first terminal portion 31 may be the same as the number of the protrusions 42 of the nut 4 or may be larger than the number of the protrusions 42. That is, the number of the housing holes 33 included in the first terminal portion 31 is determined such that the housing holes 33 can be engaged with all the protrusions 42.

The housing hole 33 of the bus bar 3 may not pierce through the first terminal portion 31. For example, the housing hole 33 may be a recess formed in the first terminal portion 31.

The shape of the nut 4 when viewed from the direction of the center axis 4x may be a shape different from the rectangle. For example, the shape of the nut 4 may be a polygon different from the rectangle.

The contents disclosed in the embodiment explained above can be combined and executed as appropriate.

In the terminal block according to the present embodiment, the nut includes the facing surface facing the bus bar and the protrusion protruding from the facing surface toward the bus bar, and the bus bar includes the housing hole that engages with the protrusion to restrict the rotation of the nut. With the terminal block according to the present embodiment, there is an effect that it is possible to suppress an increase in the size of the housing by restricting the rotation of the nut with the housing hole of the bus bar.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar including a through hole;
a nut including a screw hole;
a housing including a holding portion that holds the bus bar, and a recess that holds the nut with the screw hole caused to face the through hole; and
a bolt inserted into the through hole and screwed in the nut housed in the recess, wherein
the nut includes a facing surface facing the bus bar, and a protrusion protruding from the facing surface toward the bus bar, and
the bus bar includes a housing hole that engages with the protrusion and restricts rotation of the nut.

2. The terminal block according to claim 1, wherein
a shape of the nut is a rectangle when viewed from a direction of a center axis of the screw hole, and
the protrusion is disposed on a diagonal line of the rectangle.

3. The terminal block according to claim 2, wherein
the nut includes two protrusions disposed on the diagonal line with the screw hole interposed therebetween.

4. The terminal block according to claim 1, wherein
the recess holds the nut at a position where the protrusion is caused to face the housing hole.

5. The terminal block according to claim 1, wherein
the nut includes a plurality of the protrusions,
the plurality of protrusions are disposed concentrically centering on a center axis of the screw hole,
the bus bar includes a plurality of the housing holes, and
the plurality of housing holes are disposed such that one of the plurality of housing holes can engage with any of the protrusions.
